(19) United States
(12) Patent Application Publication
(10) Pub. No.: US 2025/0124491 A1
(43) Pub. Date: Apr. 17, 2025

(54) MERCHANDISE REGISTRATION DEVICE AND STORE SUPPORT SYSTEM

(71) Applicant: Toshiba Tec Kabushiki Kaisha, Tokyo (JP)

(72) Inventor: Yusuke MINOURA, Sunto Shizuoka (JP)

(21) Appl. No.: 18/736,128

(22) Filed: Jun. 6, 2024

(30) Foreign Application Priority Data
Oct. 17, 2023 (JP) 2023-179105

(51) Int. Cl. G06Q 30/0601

(52) U.S. Cl. CPC G06Q 30/0641; G06Q 30/0633

(57) ABSTRACT

In one embodiment, a mobile merchandise registration device has a display, an input unit, a communication interface, and a control unit. The control unit is configured to display a first screen on the display listing each merchandise item registered as purchase targets in a sales transaction and receive a cancellation operation, via the input unit, for cancelling the registration of a merchandise item as a purchase target. After receiving a cancellation operation, the control unit displays a cancellation operation confirmation screen on the display which includes sales retention information related to the merchandise item that is a subject of the cancellation operation. If the user confirms the cancellation operation via the confirmation screen, the control unit causes the registration of the item to be cancelled from the sales transaction.

### CROSS-REFERENCE TO RELATED APPLICATION

This application is based upon and claims the benefit of priority from Japanese Patent Application No. 2023-179105, filed Oct. 17, 2023, the entire contents of which are incorporated herein by reference.

### FIELD

Embodiments of the present disclosure relate generally to merchandise registration device and a store support system.

### BACKGROUND

In recent years, in stores such as supermarkets, a system in which customers themselves register merchandise while moving around the sales floor has been adopted. In one such system, a shopping cart equipped with a tablet terminal and a scanner has been used.

In this system, a shopping customer uses the scanner to scan a code symbol (also referred to as a “merchandise barcode”) such as a barcode attached to a merchandise item that the customer wishes to purchase. Merchandise registration is performed based on the merchandise codes read by the scanner, and the registered merchandise information (merchandise code, merchandise name, price, and the like) is stored in the tablet terminal or a store server that communicates with the tablet terminal. The merchandise information is then subsequently transferred to an accounting machine that performs settlement processing when the customer pays the price to complete the sales transaction for the registered merchandise. The customer generally makes the payment using an accounting machine that the customer operates by himself or herself.

Another system has been adopted that allows a customer to register merchandise using their own customer-provided terminals, such as a smartphone, instead of using a tablet terminal or a scanner provided by the store. In such a system, a shopping application program is installed on the customer's smartphone. Then, the merchandise barcodes can be imaged with the smartphone camera and the merchandise code is read from the picture or the like.

In such systems, a customer can register a merchandise item by scanning the merchandise barcode while walking around the store, but it is also possible to cancel a merchandise registration. Specifically, after cancelling a merchandise registration, the customer may continue shopping by returning the cancelled merchandise item to a display shelf or the like. However, when a merchandise registration is easily canceled, it may lead to a decrease in sales for the store, so it may be a goal for the store to reduce cancellations by customers.

In recent years, a technology has been proposed that detects that a merchandise item has been taken from or returned to a display shelf and then changes the price of the merchandise item when the number of times the merchandise item is shunned (picked up then put back) reaches a threshold, but it is difficult to similarly address customer cancellation behaviors related to returning previously registered merchandise items to the display shelf.

### BRIEF DESCRIPTION OF THE DRAWINGS

FIG. 1 is a diagram schematically illustrating a store support system according to an embodiment.

FIG. 2 is a block diagram of a server device according to an embodiment.

FIG. 3 is a diagram illustrating an example of a data structure of a merchandise master according to an embodiment.

FIG. 4 is a diagram illustrating an example of a data structure of a terminal management table according to an embodiment.

FIG. 5 is a diagram illustrating an example of a data structure of a transaction information management table according to an embodiment.

FIG. 6 is a diagram illustrating an example of a data structure of an inventory management table according to an embodiment.

FIG. 7 is a diagram illustrating an example of a data structure of a returned-to-shelf merchandise table according to an embodiment.

FIG. 8 is a diagram illustrating an example of a data structure of a best-selling merchandise table according to an embodiment.

FIG. 9 is a diagram illustrating an example of a data structure of a recommended merchandise table according to an embodiment.

FIG. 10 is a block diagram of a customer terminal according to an embodiment.

FIG. 11 is a block diagram illustrating certain functional aspects of a server device according to an embodiment.

FIG. 12 is a block diagram illustrating certain functional aspects of a customer terminal according to an embodiment.

FIG. 13 is a sequence chart illustrating an example of operations of a store support system according to an embodiment.

FIG. 14 is a diagram illustrating an example of a top screen displayed by a customer terminal of an embodiment.

FIG. 15 is a sequence chart illustrating an example of operations of a store support system according to an embodiment.

FIG. 16 is a diagram illustrating an example of a first sales promotion screen displayed by a customer terminal of an embodiment.

FIG. 17 is a sequence chart illustrating an example of operations of a store support system according to an embodiment.

FIG. 18 is a diagram illustrating an example of a transaction information screen displayed by a customer terminal of an embodiment.

FIG. 19 is a diagram illustrating an example of a second sales promotion screen displayed by a customer terminal of an embodiment.

FIG. 20 is a sequence chart illustrating an example of operations of a store support system according to an embodiment.

FIG. 21 is a diagram illustrating an example of a confirmation screen displayed by a customer terminal of an FIG. 22 is a sequence chart illustrating an example of operations of a store support system according to an embodiment.

### DETAILED DESCRIPTION

An embodiment of the present disclosure provides a technological improvement to merchandise registration devices and store support systems for reducing cancellation of merchandise items already registered as purchase targets.

According to one embodiment, a mobile merchandise registration device includes a display to display information to a user while shopping in a store, an input unit for receiving user inputs from the user, a communication interface to connect to a server device tracking a sales transaction of the user at the store, and a control unit. The control unit is configured to: display a first screen on the display, the first screen for listing each merchandise item registered as purchase targets in the sales transaction; receive a cancellation operation, via the input unit, for cancelling the registration of a merchandise item as a purchase target listed on the first screen; after receiving the cancellation operation, display a second screen on the display, the second screen being a cancellation operation confirmation screen and including sales retention information regarding the merchandise item that is a subject of the cancellation operation; and cause the registration of the merchandise item that is the subject of the cancellation operation to be cancelled if the user confirms the cancellation operation via the second screen.

Hereinafter, an information processing device and a store support system for merchandise registration according to certain example embodiments will be described. The present disclosure is not limited to the example embodiments. In this context, merchandise registration refers to storing (registering) information about merchandise to be purchased by a customer in a sales transaction at a retail store or the like.

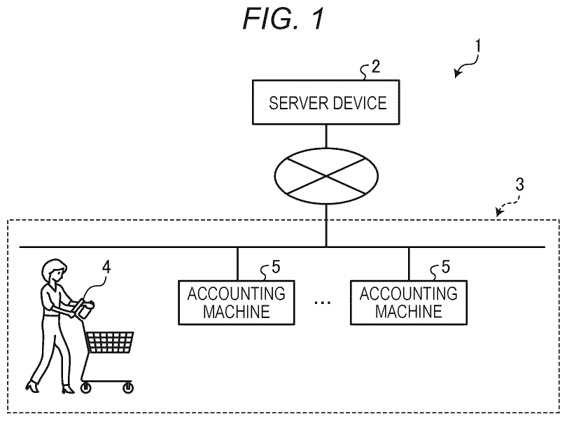

FIG. 1 is a diagram schematically illustrating a store support system 1. The store support system 1 is used in a store such as a supermarket that sells merchandise. The store support system 1 includes a server device 2 and a mobile self-checkout system 3. The server device 2 and the mobile self-checkout system 3 are communicably connected to each other via a network such as a local area network (LAN) or the Internet.

The mobile self-checkout system 3 is adopted in a store and includes a customer terminal 4 and an accounting machine 5 that are to be operated by customers themselves. The customer terminal 4 and the accounting machine 5 are communicably connected to each other via an in-store network such as a wired or wireless local area network (LAN). The customer terminal 4 and the accounting machine 5 are communicably connected to the server device 2 via the in-store network.

The customer terminal 4 may be able to communicate with the server device 2 without going through the in-store network. For example, the customer terminal 4 may be communicably connected to the server device 2 via a wide area network such as the Internet or a mobile communication network. Other various devices may be connected to the in-store network. For example, a point-of-sale (POS) terminal at which a store employee performs operations related to merchandise registration and payment, a self-service POS terminal where a customer performs operations related to merchandise registration and payment, a semi-self-service POS system where a store employee performs operations related to merchandise registration but a customer performs operations related to payment may be connected to the in-store network. The number of customer terminals 4 and accounting machines 5 is not limited to the illustrated example.

The server device 2 is, for example, a store server. The server device 2 receives information indicating (notifying) that the customer has entered the store or information indicating the start of a transaction (collectively referred to as store entry information) from the customer terminal 4. The store entry information includes a company code or a store code of the store where the customer is presently located. By receiving the store entry information from the customer terminal 4, the server device 2 can specify the store where the customer terminal 4 is located. The server device 2 issues a terminal code and a transaction code to the customer terminal 4 that sent the store entry information. The terminal code is terminal specifying information that uniquely specifies the customer terminal 4, and the transaction code is transaction specifying information that uniquely specifies the transaction. When the customer terminal 4 is a terminal device that the store lends to the customer, the customer terminal 4 may store a terminal code issued in advance and the customer terminal 4 may be specified using this stored terminal code.

When the customer terminal 4 transmits various types of information to the server device 2, the customer terminal 4 transmits the terminal code and the transaction code along therewith. The server device 2 can identify the customer terminal 4 sending information by the terminal code and/or transaction code. In the present embodiment, a plurality of transaction codes cannot be issued to the same customer terminal 4 while the customer is shopping. That is, since there is a one-to-one correspondence between the terminal code and the transaction code, either code can provide the functions of the other code.

Specifically, a transaction can be identified by the terminal code. Therefore, the terminal code is also an example of transaction specifying information. The customer terminal 4 can also or instead be identified by the transaction code. Therefore, the transaction code is also an example of terminal specifying information. Therefore, in the following, it should be assumed that the terminal code and the transaction code can be replaced with each other as appropriate. For example, the server device 2 might issue only the terminal code or the transaction code.

The server device 2 receives a registration request from a customer terminal 4. The registration request includes the terminal code (and/or transaction code) along with a merchandise code read by the customer terminal 4. The server device 2 manages merchandise information for a store and thus can read or otherwise the merchandise information corresponding to the merchandise code provided in the registration request received from the customer terminal 4. The server device 2 thus registers the corresponding merchandise information for the provided merchandise code as a transaction target (an item to be purchased). In other words, the server device 2 registers the merchandise information as a part stored transaction of information. The transaction information includes various types of information necessary for a customer to make a payment for the sales transaction, such as registered merchandise information. The merchandise information includes the merchandise code, the merchandise name, and the price. As such, the server device 2 manages transaction information for each customer, or in other words, for each terminal code, in real time.

The server device 2 also receives a transaction information request from the accounting machine 5. The transaction information request is a request for transaction information for a customer about to make a payment for settlement of a transaction. The request includes the transaction code that specifies the particular transaction to be paid. After the server device 2 receives the transaction information request, the server device 2 transmits the transaction information linked to the transaction code in the transaction information request to the accounting machine 5.

The server device 2 may be a plurality of computers working in conjunction. In other words, the functions of the server device 2 may be distributed among a plurality of computers.

The customer terminal 4 is an example of an information processing device for merchandise registration or a merchandise registration device. The customer terminal 4 is moveable and operated by a customer as the customer moves around the store. For example, the customer terminal 4 may be a mobile terminal such as a smartphone owned by the customer. The customer terminal 4 may be a mobile terminal that the store lends to the customer or a tablet terminal attached to a shopping cart. In the present embodiment, the customer terminal 4 is a smartphone owned by the customer.

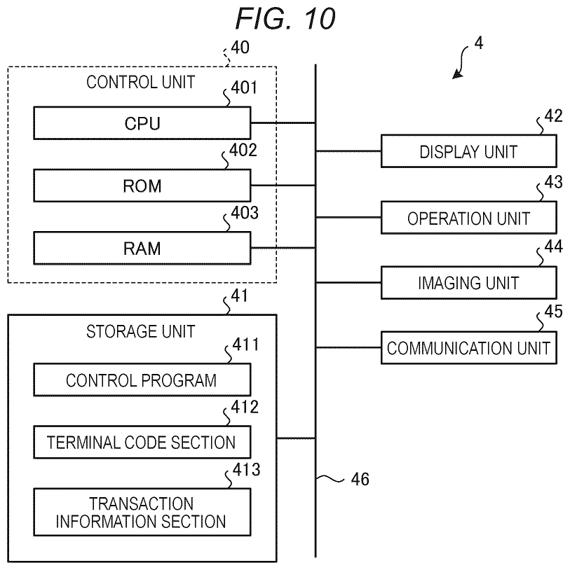

An application program for a mobile self-checkout system is installed in the customer terminal 4. The customer terminal 4 captures an image of a merchandise barcode using an imaging unit 44 (see FIG. 10) and reads the merchandise code. The customer terminal 4 transmits and receives various types of information to and from the server device 2.

The accounting machine 5 is a so-called self-operated type accounting machine that is operated by the customer themselves. The accounting machine 5 includes a scanner unit that can read code symbols such as barcodes and two-dimensional codes. The accounting machine 5 uses the scanner unit to read a transaction code from a barcode for accounting (hereinafter also referred to as an accounting barcode) that is displayed on the customer terminal 4. The accounting machine 5 transmits a transaction information request including the read transaction code to the server device 2.

When the accounting machine 5 receives transaction information from the server device 2 as a response to the transaction information request, the accounting machine 5 performs an accounting process based on the transaction information. The accounting process is a process for paying for merchandise to be purchased by a customer. In cash payments, the accounting process includes, for example, displaying transaction information, calculating the amount of coin, dispensing coin, and the like, and in cashless payments, the accounting process includes transmitting and receiving various types of information with a payment server of a payment provider. The accounting machine 5 transmits and receives various types of information to and from the server device 2.

Next, configurations of the server device 2 and customer terminal 4 will be described.

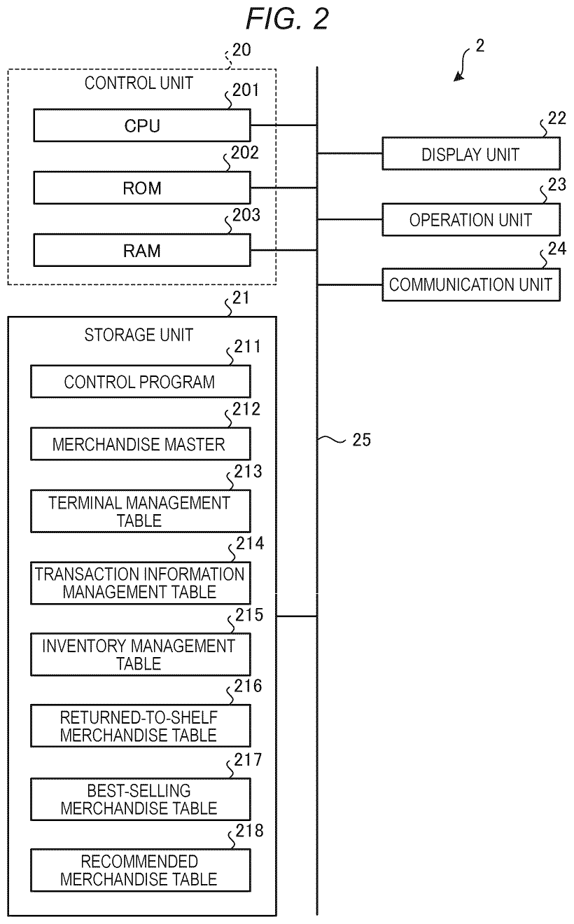

First, the server device 2 will be described. FIG. 2 is a block diagram of the server device 2. The server device 2 includes a control unit 20, a storage unit 21, a display unit 22, an operation unit 23 (an input unit), and a communication unit 24. The control unit 20, the storage unit 21, the display unit 22, the operation unit 23, and the communication unit 24 are connected to each other via a bus 25 or the like.

The control unit 20 may comprise a computer including a central processing unit (CPU) 201, a read only memory (ROM) 202, and a random access memory (RAM) 203. The CPU 201, the ROM 202, and the RAM 203 are connected to each other via the bus 25.

The CPU 201 controls the entire operation of the server device 2. The ROM 202 stores various programs such as programs used to drive the CPU 201 and various types of data. The RAM 203 is used as a work area for the CPU 201 and loads various programs and various types of data stored in the ROM 202 and the storage unit 21. The control unit 20 executes various control processes for the server device 2 by causing the CPU 201 to operate according to a control program stored in the ROM 202 or the storage unit 21 and loaded in the RAM 203.

The storage unit 21 can be a storage medium such as a hard disk drive (HDD) or a flash memory and maintains stored contents even when power is cut off. The storage unit 21 stores a control program 211, a merchandise master 212, a terminal management table 213, a transaction information management table 214, an inventory management table 215, a returned-to-shelf merchandise table 216, a best-selling merchandise table 217, a recommended merchandise table 218, and the like.

The control program 211 is a variety of programs that can be executed by the CPU 201. For example, the control program 211 includes a program a for implementing functional configuration described below.

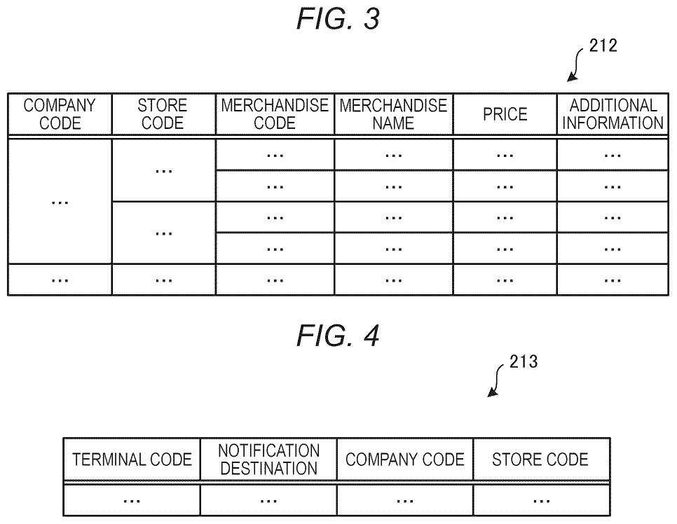

The merchandise master 212 is a master file that stores information about merchandise handled at each store. The merchandise master 212 can be updated based on information acquired from each store. Since the merchandise handled at each store can change daily or otherwise, the merchandise master 212 may be updated as appropriate by the store. FIG. 3 is a diagram illustrating an example of a data structure of the merchandise master. The merchandise master 212 stores entries for a company code, a store code, a merchandise code, a merchandise name, a price, additional information, and the like in association with each other.

The company code entry is information that specifies a company that manages the store that uses the store support system 1. The store code entry is information that specifies a store that uses the store support system 1. When a plurality of stores of one company use the store support system 1, a plurality of store codes are associated with the same company code.

The merchandise code entry is information that specifies particular merchandise. Since a large number of items can be sold at one store, a store code will generally be associated with a plurality of merchandise codes. The merchandise name entry is information indicating the name of the merchandise. The price entry is information indicating the price of the merchandise corresponding to the merchandise code. The merchandise names and prices are associated with the merchandise codes on a one-to-one basis. The additional information entry stores any additional information regarding the merchandise that might be considered relevant or useful. For example, when the merchandise is an item eligible for a price reduction or discount, then information indicating that the merchandise is eligible for a price reduction or discount along with information indicating the amount of price reduction or discount rate can be stored in the additional information entry field(s).

The terminal management table 213 is a data table for managing the customer terminal(s) 4 used in the mobile self-checkout system 3. FIG. 4 is a diagram illustrating an example of a data structure of the terminal management table 213. The terminal management table 213 stores entries for a terminal code, a notification destination, a company code, and a store code in association with each other.

The terminal code entry is information that specifies a customer terminal 4 that uses the store support system 1. When the server device 2 receives store entry information from a customer terminal 4, the server device 2 issues a terminal code to the customer terminal 4 and registers the customer terminal 4 in the terminal management table 213. The terminal code may be an identification number or the like that the customer terminal 4 itself has, such as International Mobile Equipment Identity (IMEI). In such case, the customer terminal 4 may include its own identification number in the store entry information, and the server device 2 may use the identification number in the store entry information as the terminal code.

The notification destination entry is information indicating a notification destination for the customer terminal 4, such as a communication address of the customer terminal 4. The company code entry is information that specifies a company that manages the store where the customer terminal 4 is presently located. The store code entry is information that specifies the store where the customer terminal 4 is located. The notification destination, company code, and store code are registered based on store entry information that is received from the customer terminal 4. Among the pieces of information registered in the terminal management table 213, those pieces of information related to terminal codes of customers who have completed payment for a transaction may be deleted after appropriate time or the like. As such, since the same terminal code can be reused many times, the number of required digits in the terminal code can be reduced.

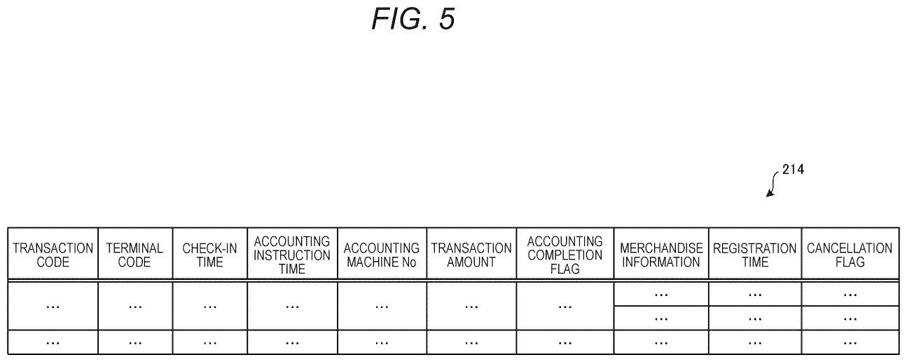

The transaction information management table 214 is a data table that manages transaction information for each store for each transaction. The transaction information management table 214 can be updated based on information from the customer terminal 4 and the accounting machine 5, for example. FIG. 5 is a diagram illustrating an example of a data structure of the transaction information management table 214. The transaction information management table 214 stores entries for a transaction code, a terminal code, a check-in time, an accounting instruction time, an accounting machine number (“accounting machine No”), a transaction amount, an accounting completion flag, merchandise information, a registration time, and a cancellation flag in association with each other.

The transaction code entry is information that specifies a particular transaction. When the server device 2 receives store entry information from the customer terminal 4, the server device 2 issues a transaction code and a terminal code (if necessary) and registers these codes in the transaction information management table 214. The check-in time entry is information indicating the time when the customer entered the store, for example, the time when the server device 2 received store entry information from the customer terminal 4.

The accounting instruction time entry is information indicating the time when the server device 2 received an accounting instruction from the customer terminal 4. The “accounting machine No” entry is information that specifies the accounting machine 5 that executed the accounting process for the transaction. In other words, the “accounting machine No” entry is information that specifies the accounting machine 5 that was used to read the transaction code from the accounting screen of the customer terminal 4. The “accounting machine No” is registered based on a transaction information request sent from the accounting machine 5.

The transaction amount entry is information indicating the total amount due for merchandise (summed prices) in a transaction. The accounting completion flag is information indicating whether the payment for the transaction has been completed, in other words, whether the accounting process at the accounting machine 5 has been completed. The accounting completion flag is registered as a value of “1” when the payment related to the transaction has been completed, and a value of “0” when the payment has not been completed. The accounting completion flag is rewritten to “1” based on an accounting completion notification being obtained from the accounting machine 5.

The merchandise information entry is information indicating a merchandise code, a merchandise name, and a price. When a plurality of merchandise items are purchased in one transaction, a plurality of pieces of merchandise information are registered in correspondence with the transaction code. The registration time entry is information indicating the time when the merchandise information was registered. The cancellation flag is information indicating whether merchandise information has been cancelled. When merchandise information has been cancelled, a value of “1” is registered, and when the information has not been cancelled, a value of “0” is registered. The cancellation flag is rewritten to “1” based on cancellation information being sent from the customer terminal 4. In this context, cancellation information is information that instructs a canceling of a previous merchandise registration and includes a merchandise code for is the registered item to be canceled.

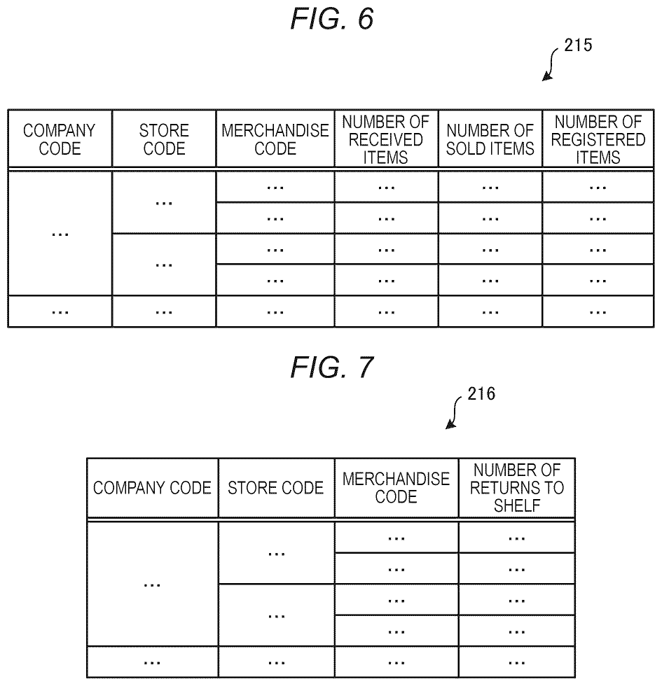

The inventory management table 215 is a data table that manages (tracks) the number of merchandise items in stock at each store. The inventory management table 215 is updated based on, for example, information acquired from each store and the merchandise items registered in the transaction information management table 214. Since the number of merchandise items in stock changes moment to moment based on purchases, deliveries, returns, and the like, the inventory management table 215 can be updated as appropriate. FIG. 6 is a diagram illustrating an example of a data structure of the inventory management table 215. The inventory management table 215 stores entries for a company code, a store code, merchandise codes, number of received items, number of sold items, number of registered items, and the like in association with each other.

The company code, store code, and merchandise code are the same information as the merchandise master 212. The number of received items is information indicating the available number of items corresponding to a merchandise code. The number of sold items is information indicating the number of items sold corresponding to a merchandise code. The number of registered items is information indicating the number of registered merchandise items corresponding to a merchandise code. In this context, the number of registered items is the number of items before sales and then changes over to the number of sold items as these registered items go through the accounting process. In the following, a value obtained by subtracting the number of sold items from the number of received items is also referred to as a “number of items in stock”. A value obtained by subtracting a total value of the number of sold items and the number of registered items from the number of received items is also referred to as a “predicted number of items in stock”.

The returned-to-shelf merchandise table 216 is a data table that manages (tracks) merchandise items at each store that were registered in a transaction at one time but then cancelled at each store, that is, merchandise items that have been or will be returned to a merchandise shelf or the like. The returned-to-shelf merchandise table 216 is updated, for example, based on a state of the cancellation flags of the items registered in the transaction information management table 214. FIG. 7 is a diagram illustrating an example of a data structure of the returned-to-shelf merchandise table 216. The returned-to-shelf merchandise table 216 stores entries for a company code, a store code, a merchandise code, and a number of returns to shelf in association with each other.

The company code, store code, and merchandise code are the same information as the merchandise master 212. The number of returns to shelf entry is information indicating the number of times a merchandise item corresponding to a merchandise code has been cancelled from a transaction at the store corresponding to the store code. Specifically, the number of returns to shelf is a value obtained by counting the number of merchandise items for which the cancellation flag has been set to “1” in the transaction information management table 214 for each store code.

The returned-to-shelf merchandise table 216 may be configured to store a value (hereinafter also referred to as a returned-to-shelf rate) obtained by dividing the number of returns to shelf by the number of sold items. Here, the returned-to-shelf rate can be determined by dividing the number of returns to shelf by the number of sold items in the inventory management table 215 by store code and merchandise code. In some cases, a returned-to-shelf rate may be expressed as an index value divided into a plurality of levels such as “high”, “medium”, and “low” instead of a numerical value.

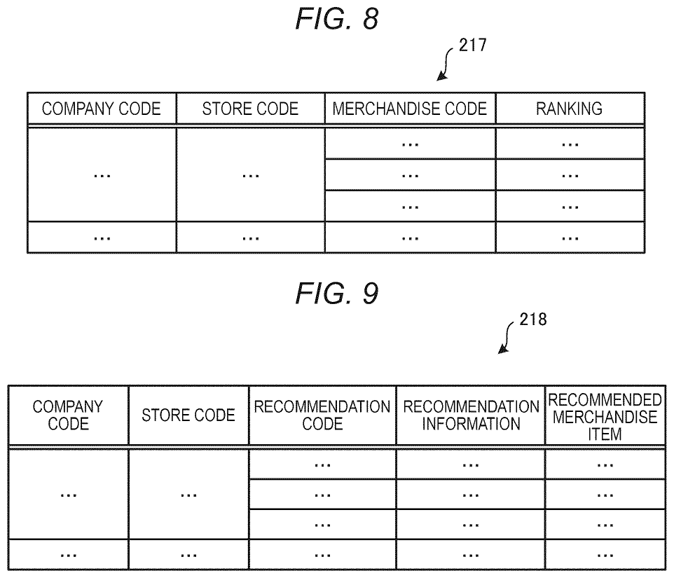

The best-selling merchandise table 217 is a data table that manages (tracks) best-selling merchandise items, that is, items that sell well at a store. The best-selling merchandise items can be determined based on various indicators, such as total number sold or number registered) a total within predetermined time frame. A threshold value may be set to determine whether particular items are in a high sales rank, or the like. The best-selling merchandise table 217 is updated based on, for example, the number of registered items for each merchandise code in the transaction information management table 214. FIG. 8 is a diagram illustrating an example of a data structure of the best-selling merchandise table 217. The best-selling merchandise table 217 stores entries for a company code, store code, merchandise code, a ranking (sales ranking), and the like in association with each other.

The company code, store code, and merchandise code are the same information as the merchandise master 212. The ranking entry is information indicating the best-selling merchandise items. Here, the ranking is based on the number of sold items. Specifically, the best-selling merchandise table 217 in FIG. 8 shows an example in which the merchandise items with a high rank have a greater number sold and are set as best-selling merchandise items. For example, the merchandise codes of the top three merchandise items by numbers sold are registered in the table.

The recommended merchandise table 218 is a data table that manages (tracks) merchandise items to be recommended to customers for purchase (hereinafter also referred to as recommended merchandise items) at each store. Recommended merchandise items can be set freely by the store or otherwise. For example, a recommended merchandise item may be an item that is eligible for a price reduction or discount (hereinafter also referred to as a price discount merchandise item). For example, the recommended merchandise items may be a set (a group) of merchandise items (each referred to as set discount merchandise items) that are eligible for price reduction or discount when the whole group is purchased in the same transaction. For example, the recommended merchandise items may be ingredients (recipe merchandise items) in a recipe for a dish. A recommended merchandise item may be one that is being actively promoted by the store or the manufacturer of the merchandise item (for example, a new arrival item or a new merchandise item).

FIG. 9 is a diagram illustrating an example of a data structure of the recommended merchandise table 218. The recommended merchandise table 218 stores entries for a company code, a store code, a recommendation code, recommendation information, recommended merchandise items, and the like in association with each other.

The company code, store code, and merchandise code are the same information as the merchandise master 212. The recommendation code entry is information that can identify a particular type of recommended merchandise item, such as a price discount merchandise item, a set (group) discount merchandise item, or a recipe merchandise item. The recommendation information entry includes information regarding the recommended merchandise items such as price discount merchandise items and set discount merchandise items. For example, the recommendation information includes information such as the price reduction amount or discount rate. For example, when the recommended merchandise item is a recipe merchandise item, the recommendation information includes the name of the dish corresponding to the recipe. The recommendation information may include an introduction or a recommendation that introduces or explains a merchandise item created by a store employee or a manufacturer that manufactures the merchandise item. The recommended merchandise item entry is information indicating the merchandise code of the merchandise item targeted by a recommended merchandise item.

The terminal management table 213 and the transaction information management table 214 can be updated in real time. The inventory management table 215, the returned-to-shelf merchandise table 216, the best-selling merchandise table 217, and the recommended merchandise table 218 may be updated in real time or at intervals (for example, every 5 minutes).

Returning to FIG. 2, the hardware configuration of the server device 2 will be described.

The display unit 22 comprises, for example, a liquid crystal panel and displays various types of information. The operation unit 23 is for inputting information to the control unit 20, and includes, for example, a keyboard, a touch panel, a mouse, and the like.

The communication unit 24 is an interface for communicating with external devices such as the customer terminal 4 and the accounting machine 5. By being connected to the external devices via the communication unit 24, the control unit 20 can transmit and receive information (data) to and from the external devices.

Next, the customer terminal 4 will be described. FIG. 10 is a block diagram of the customer terminal 4. The customer terminal 4 includes a control unit 40, a storage unit 41, a display unit 42, an operation unit 43 (user input unit), an imaging unit 44, and a communication unit 45. The control unit 40, the storage unit 41, the display unit 42, the operation unit 43, the imaging unit 44, and the communication unit 45 are connected to each other via a bus 46 or the like.

The control unit 40 may comprise a computer including a CPU 401, a ROM 402, and a RAM 403. The CPU 401, the ROM 402, and the RAM 403 are connected to each other via the bus 46.

The CPU 401 controls the entire operation of the customer terminal 4. The ROM 402 stores various programs such as programs used to drive the CPU 401 and various types of data. The RAM 403 is used as a work area for the CPU 401 and loads various programs and various types of data stored in the ROM 402 and the storage unit 41. The control unit 40 executes various control processes for the customer terminal 4 when the CPU 401 operates according to a control program stored in the ROM 402 or the storage unit 41 and loaded in the RAM 403.

The storage unit 41 is a storage medium such as an HDD or a flash memory and maintains the stored contents even when the power is cut off. The storage unit 41 stores a control program 411, a terminal code section 412, and a transaction information section 413.

The control program 411 may be one or more software programs that can be executed by the CPU 401. For example, the control program 411 can be or include an application program for causing the customer terminal 4 to function as an input device and an output device for various types of information in the mobile self-checkout system. The control program 411 includes instructions for implementing functions described below.

The terminal code section 412 stores the terminal code received from the server device 2. The terminal code is issued by the server device 2 in response to store entry information from the customer terminal 4.

The transaction section information 413 stores transaction information in which a transaction code received from the server device 2 is associated with merchandise information registered in the server device 2. Specifically, the merchandise information registered by the server device 2 is sequentially listed in the transaction information section 413 in association with the transaction code.

When the customer terminal 4 receives the accounting completion notification from the server device 2, the information stored in the terminal code section 412 and the transaction information section 413 can be cleared. The terminal code section 412 and the transaction information section 413 can then store new information for a transaction.

The display unit 42 comprises, for example, a liquid crystal panel and displays various types of information. The display unit 42 displays merchandise information of the merchandise items registered in the server device 2, the total price of the registered merchandise items, and the like. The display unit 42 displays an accounting screen. An accounting barcode that can be read by the accounting machine 5 is displayed on the accounting screen.

The operation unit 43 can comprise a touch panel provided on a surface of the display unit 42, for example, and sends information to the control unit 40 according to a position touched by a user. When a customer operates a button or icon displayed on the display unit 42, the operation unit 43 sends information corresponding to the operated (selected) button or icon to the control unit 40.

The imaging unit 44 includes an imaging device having an imaging element such as CCD or CMOS. The imaging unit 44 acquires a picture (images) a code symbol, such as a two-dimensional code displayed at an entrance of the store or a barcode attached to a merchandise item. The imaging unit 44 sends image data or video data (“imaging data”) to the control unit 40. The control unit 40 reads information in the image of the code symbol. In some examples, the customer terminal 4 recognizes a merchandise code of a merchandise item by using so-called full object recognition technology or generic object recognition. In such cases, the imaging unit 44 takes a picture (image) of the merchandise item and sends the image to the control unit 40 for analysis (recognition).

The communication unit 45 is an interface for communicating with external devices such as the server device 2. By being connected to the external devices via the communication unit 45, the control unit 40 can transmit and receive information (data) to and from the external devices.

Next, functional aspects of the server device 2 and the customer terminal 4 will be described.

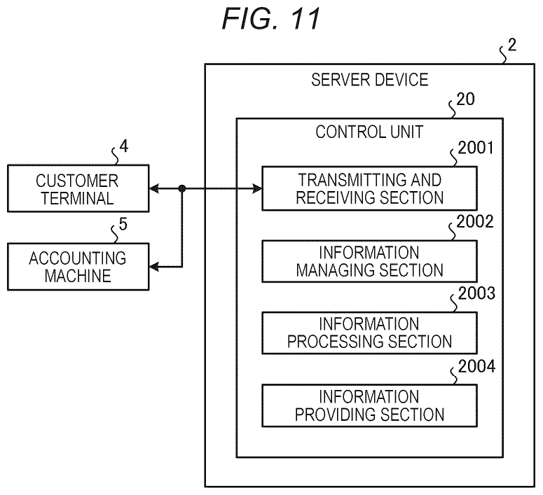

First, the functions of the server device 2 will be described. FIG. 11 is a block diagram illustrating an functional aspects of the server device 2. The control unit 20 functions as a transmitting and receiving section 2001, an information managing section 2002, an information processing section 2003, and an information providing section 2004 when the CPU 201 operates according to a control program stored in the ROM 202 or the storage unit 21. Each of the described functions may be implemented as hardware such as a dedicated circuit.

The transmitting and receiving section 2001 transmits and receives various types of information to and from the customer terminal 4 and the accounting machine 5. For example, the transmitting and receiving section 2001 receives store entry information from the customer terminal 4, and transmits a terminal code and a transaction code to the customer terminal 4 that sent the store entry information.

The transmitting and receiving section 2001 receives an information request from the customer terminal 4, and in response, transmits sales promotion information indicating best-selling merchandise items, recommended merchandise items, and the like to the customer terminal 4. In this context, the information request requests information regarding merchandise items such as which items are best-selling merchandise items and/or recommended merchandise items. The information request includes a terminal code.

The transmitting and receiving section 2001 receives a registration request including a terminal code and a merchandise code from the customer terminal 4, and transmits the registered merchandise information and the transaction amount as a response to the customer terminal 4 sending the registration request.

When a cancellation request (including a terminal code and a merchandise code) is transmitted from the customer terminal 4, the transmitting and receiving section 2001 transmits retention information and a confirmation screen display instruction (for displaying a screen for confirming the terminal 4 that sent the screen display cancellation request. The confirmation cancellation) to the customer instruction instructs the customer terminal 4 to display a confirmation screen for confirming execution of the cancellation. Once the customer terminal 4 confirms execution of the cancellation from the confirmation screen, the transmitting and receiving section 2001 now formally receives the cancellation request. The transmitting and receiving section 2001 then transmits a cancellation completion notification to the customer terminal 4 as a response to the cancellation request. The cancellation completion notification is information indicating that cancellation of merchandise information has been completed, and includes a merchandise code. When an instruction to stop the cancellation is given from the customer terminal 4 based on the confirmation screen, the transmitting and receiving section 2001 discards the cancellation request.

The transmitting and receiving section 2001 receives an accounting instruction including the transaction code from the customer terminal 4, and transmits the transaction amount of the transaction specified by the transaction code and an accounting screen display instruction to the customer terminal 4 that sent the accounting instruction. In this context, the accounting instruction is information indicating that merchandise registration has been completed. The accounting screen display instruction causes the customer terminal 4 to display the accounting barcode. In some examples, calculation of the transaction amount may be performed by the customer terminal 4.

The transmitting and receiving section 2001 receives a transaction information request including a transaction code from the accounting machine 5 and transmits the transaction information specified by the transaction code in response. The transmitting and receiving section 2001 receives the accounting completion notification from the accounting machine 5. The accounting completion notification is information indicating that payment for a transaction has been completed and includes a transaction code.

The transmitting and receiving section 2001 receives a recommended merchandise registration request from a store. The recommended merchandise registration request is information requesting registration of a recommended merchandise item, and includes a company code, a store code, a recommendation code, recommendation information, a merchandise code of the recommended merchandise item, and the like.

The information managing section 2002 manages various types of information based on the information received by the transmitting and receiving section 2001 and the like. In this context, managing information means writing various types of information (data) to the storage unit 21 and/or updating existing information.

For example, when the transmitting and receiving section 2001 receives store entry information, the information managing section 2002 writes the issued (or received) terminal code and the transaction code in the terminal management table 213 and the transaction information management table 214.

When the transmitting and receiving section 2001 receives a registration request, the information managing section 2002 registers merchandise information corresponding to the merchandise code included in the registration request into the transaction information management table 214. Specifically, the information managing 2002 section refers to the terminal management table 213 and reads out the company code and the store code corresponding to the terminal code included in the registration request. Then, the information managing section 2002 reads out merchandise information that is associated with the company code and the store code and corresponds to the merchandise code in the registration request from the merchandise master 212, and registers the read information in the transaction information management table 214.

When the transmitting and receiving section 2001 receives a cancellation request, the information managing section 2002 rewrites a cancellation flag in the merchandise information corresponding to the terminal code and the merchandise code in the cancellation request to “1”. Specifically, the information managing section 2002 refers to the terminal management table 213 and reads out the company code and the store code corresponding to the terminal code in the cancellation request. The information managing section 2002 then rewrites the cancellation flag corresponding to the merchandise code in the cancellation request to “1”.

As described above, the information managing section 2002 manages the transaction information management table 214 that stores transaction specifying information (transaction code or terminal code) and transaction information in association with each other, and is an example of a transaction managing means.

The information managing section 2002 updates the number of sold items and the number of registered items in the inventory management table 215 based on the merchandise information registered in the transaction information management table 214. The information managing section 2002 adds up the numbers of items for each merchandise code registered in the transaction information management table 214 for the same store code. The information managing section 2002 regards those items for which the accounting completion flag is “1” as the number of sold items for each merchandise code, and regards those items for which the accounting completion flag is “0” and the cancellation flag is “0” as the number of registered items. Then, the information managing section 2002 updates the inventory management table 215 by registering the number of sold items and the number of registered items derived for each store code and merchandise code in the inventory management table 215. The information managing section 2002 may update the inventory management table 215 in real time or at predetermined time intervals (for example, every 5 minutes).

The information managing section 2002 updates the number of items returned to shelf in the returned-to-shelf merchandise table 216 based on a state of the cancellation flag of the merchandise information registered in the transaction information management table 214. The information managing section 2002 adds up the numbers of items for each merchandise code for which the cancellation flag is “1” in the transaction information management table 214 for each store code. Then, the information managing section 2002 updates the returned-to-shelf merchandise table 216 with the total result derived for each store code and merchandise code. The information managing section 2002 may update the returned-to-shelf merchandise table 216 in real time or at predetermined time intervals (for example, every 5 minutes). The information managing section 2002 may use the number of sold items registered in the inventory management table 215 and calculate a returned-to-shelf rate by dividing the number of returns to shelf by the number of sold items with the same store code and merchandise code in the returned-to-shelf merchandise table 216.

The information managing section 2002 updates the ranking of the best-selling merchandise table 217 based on the merchandise information registered in the transaction information management table 214. Based on date and time information such as registration date and/or time registered in the transaction information management table 214, the information managing section 2002 adds up the numbers of items for each merchandise code registered within some predetermined period of time (for example, within the last 30 minutes) before the current time. The information managing section 2002 extracts a plurality of high-ranking merchandise codes (those with higher total number of items sold for each store code). The information managing section 2002 then updates the best-selling merchandise table 217 by registering the merchandise codes extracted for each store code in the best-selling merchandise table 217 in order from the highest ranked merchandise code.

The merchandise codes to be counted may be the merchandise codes for which the accounting completion flag is “1” or may be the merchandise codes for which the cancellation flag is other than “1”. The ranking of the best-selling merchandise table 217 may be updated based on the number of sold items and/or the number of registered items in the inventory management table 215.

The information managing section 2002 updates the recommended merchandise table 218 in response to instructions from each store. For example, when the transmitting and receiving section 2001 receives the recommended merchandise registration request, the information managing section 2002 registers the company code, store code, recommendation code, recommendation information, and recommended merchandise item included in the recommended merchandise registration request into the recommended merchandise table 218.

The information processing section 2003 executes various information processing. For example, the information processing section 2003 calculates the transaction amount (total amount due) of each transaction. The information processing section 2003 also performs processing for assigning transaction codes and terminal codes, and issues these transaction codes and terminal codes as necessary.

The information providing section 2004 is an example of a providing means. The information providing section 2004 provides the customer terminal 4 with various types of information related to merchandise sales support and purchase support. For example, when the transmitting and receiving section 2001 receives an information request, the information providing section 2004 provides the customer terminal 4 with information about best-selling merchandise items and information about recommended merchandise items as sales promotion information. The information providing section 2004 reads sales promotion information about the best-selling merchandise items and recommended merchandise items associated with the specified store code from the merchandise master 212, the best-selling merchandise table 217, the recommended merchandise table 218, and the like. The information providing section 2004 then provides the sales promotion information to the customer terminal 4 via the transmitting and receiving section 2001.

When the transmitting and receiving section 2001 receives a registration request, the information providing section 2004 provides the customer terminal 4 with sales promotion information for the merchandise item related to the merchandise code in the registration request. The information providing section 2004 identifies a merchandise item related to the merchandise code in the registration request from among the recommended merchandise items in the recommended merchandise table 218 that are associated with the specified store code, and then the information providing section 2004 provides the customer terminal 4 with sales promotion information regarding the merchandise item.

For example, when the merchandise code of the registration request relates to a price discount merchandise item, the information providing section 2004 provides recommendation information associated with the price discount merchandise item as sales promotion information to the customer terminal 4 via the transmitting and receiving section 2001. For example, when the merchandise code in the registration request is part of a set sale (purchase discount group), the information providing section 2004 reads out other merchandise codes configuring the set (purchase discount group) from the recommended merchandise table 218 together with recommendation information, and provides the other codes as sales promotion information to the customer terminal 4 via the transmitting and receiving section 2001. For example, when the merchandise code of the registration request is part of recipe merchandise items, the information providing section 2004 reads out other merchandise codes among the recipe merchandise items from the recommended merchandise table 218 along with the recommendation information, and provides these other codes as sales promotion information to the customer terminal 4 via the transmitting and receiving section 2001.

When the transmitting and receiving section 2001 receives a cancellation request, the information providing section 2004 generates retention information that may be specific to the merchandise item to be cancelled and provides the generated retention information to the customer terminal 4. The information providing section 2004 generates retention information providing a reason or support for holding back (cancelling) the cancellation. More specifically, the information providing section 2004 generates retention information that includes information describing benefits resulting from the purchase of the target merchandise item and/or information describing disadvantages resulting from the cancellation of the target merchandise item. Such retention information may be generated as specific to the particular store (store code), terminal (terminal code), and/or merchandise (merchandise code).

For example, when the merchandise code in the cancellation request is a price discount merchandise item, the information providing 2004 section reads recommendation information associated with the price discount merchandise item. Then, the information providing section 2004 provides the customer terminal 4 with recommendation information as part of the retention information, which may further include information notifying that the previously established price discount will no longer be applied, a message suggesting holding back the cancellation, and the like via the transmitting and receiving section 2001.

For example, when the merchandise code in the cancellation request is among the items in a set sale grouping (discount purchase group, and there are still other merchandise codes of the grouping among the merchandise codes registered in the transaction information management table 214, the information providing section 2004 reads recommendation information for the set sale. Then, the information providing section 2004 provides the customer terminal 4 with recommendation information as part of the retention information, which may further include information notifying that the set sale grouping will no longer be successful, a message suggesting holding back the cancellation, and the like via the transmitting and receiving section 2001.

For example, when the merchandise code of the cancellation request is among a group of recipe merchandise items and there are recipe merchandise items still among the merchandise codes registered in the transaction information management table 214, the information providing section 2004 reads recommendation information related to the recipe merchandise items. Then, the information providing section 2004 provides the customer terminal 4 with this recommendation information as part of the retention information, which may further include information notifying that the recipe will no longer be possible to cook/make, a message suggesting holding back the cancellation, and the like via the transmitting and receiving section 2001.

As such, the retention information is different from sales promotion information since the purpose of sales promotion information is to promote the sale of additional merchandise items. The retention information may be considered information similar to sales promotion information having the purpose to discourage the cancellation of a merchandise item in the cancellation request. In the customer terminal 4, when cancellation of a merchandise item is instructed by a user operation, retention information is displayed on a confirmation screen for the merchandise item about to be cancelled. The user who operates the customer terminal 4 checks the displayed retention information and then determines whether to cancel the transaction, thereby reducing the possibility that the registered merchandise item will be cancelled.

The retention information may be provided every time a cancellation request is received or may be provided only for a limited number of target merchandise items. In the latter case, for example, based on the returned-to-shelf merchandise table 216, the information providing section 2004 may provide retention information for merchandise items for which the number of returns to shelf or a returned-to-shelf rate exceeds a threshold value. The information providing section 2004 refers to the appropriate returned-to-shelf merchandise table 216 and searches for the merchandise code of the cancellation request among the merchandise codes associated with the specified store code. The information providing section 2004 may provide retention information when the number of times the searched merchandise item is returned to the shelf or the returned-to-shelf rate exceeds a predetermined threshold. As a result, the information providing section 2004 can preferentially limit the cancellation of those merchandise items with a large number of returns to shelf or a high returned-to-shelf rate, thereby promoting sales of such merchandise items.

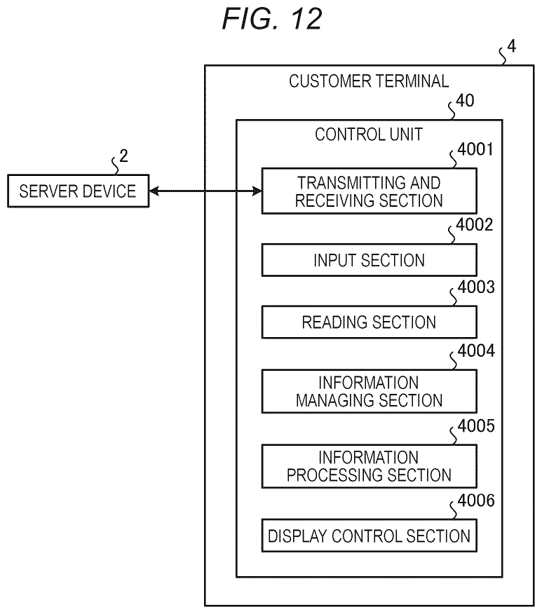

Next, functional aspects of the customer terminal 4 will be described. FIG. 12 is a block diagram certain functional aspects of the customer terminal 4. The control unit 40 functions as a transmitting and receiving section 4001, an input section 4002, a reading section 4003, an information managing section 4004, an information processing section 4005, and a display control section 4006 when the CPU 401 operates according to a control program stored in the ROM 402 and the storage unit 41. Each of the described functions may be implemented by hardware such as a dedicated circuit.

The transmitting and receiving section 4001 transmits and receives various types of information to and from the server device 2. For example, the transmitting and receiving section 4001 transmits store entry information to the server device 2 and receives a terminal code and a transaction code from the server device 2.

The transmitting and receiving section 4001 transmits an information request including a terminal code to the server device 2 and receives sales promotion information from the server device 2 in response.

The transmitting and receiving section 4001 transmits a registration request including a terminal code and a merchandise code to the server device 2, and receives registered merchandise information and transaction amount from the server device 2 as a response. That is, the transmitting and receiving section 4001 is an example of a first transmitting means.

The transmitting and receiving section 4001 transmits a cancellation request including a terminal code and a merchandise code to the server device 2, and receives retention information and a confirmation screen display instruction from the server device 2 in response. The transmitting and receiving section 4001 transmits information instructing execution of cancellation or stop of cancellation. The transmitting and receiving section 4001 receives a cancellation completion notification from the server device 2 as a response to the transmission of cancellation execution. That is, the transmitting and receiving section 4001 is an example of a cancelling means and a second transmitting means.

The transmitting and receiving section 4001 transmits an accounting instruction including a transaction code to the server device 2 and receives the transaction amount of the transaction specified by the transaction code and an instruction to display an accounting screen from the server device 2. The transmitting and receiving section 4001 receives an accounting completion notification from the server device 2.

The input section 4002 is an example of a reception means. The input section 4002 receives input of various types of information via the operation unit 43 and the imaging unit 44. For example, the input section 4002 receives inputs such as transaction start instructions, information request instructions, accounting instructions, and cancellation instructions for registered merchandise items via the operation unit 43. The input section 4002 also receives inputs such as imaging data of a code symbol displayed at an entrance of the store, a merchandise bar code attached to a merchandise item, and the like from the imaging unit 44.

The reading section 4003 extracts a two-dimensional code from the imaging data, decodes the two-dimensional code for store entry. The reading section 4003 also extracts a merchandise barcode from the imaging data, decodes the merchandise barcode to obtain a merchandise code. In some examples, the two-dimensional code and the merchandise barcode may be decoded by the server device 2. In such cases, the transmitting and receiving section 4001 transmits the imaging data to the server device 2, and receives decoded information (store information and merchandise codes) from the server device 2.

The information managing section 4004 manages various types of information received by the transmitting and receiving section 4001. In this context, managing information means writing the various types of information (data) to the storage unit 41 and/or updating existing information already in the store unit 41 as appropriate.

For example, the information managing section 4004 writes the terminal code received by the transmitting and receiving section 4001 into the terminal code section 412. The information managing section 4004 writes the transaction code and merchandise information received by the transmitting and receiving section 4001 into the transaction information section 413. Specifically, when the transmitting and receiving section 4001 receives a transaction code, the information managing section 4004 writes the transaction code to the transaction information section 413. Then, each time the transmitting and receiving section 4001 receives merchandise information registered in the server device 2, the merchandise information is associated with the appropriate transaction code and written into the transaction information section 413. When the transmitting and receiving section 4001 receives a cancellation completion notification, the information managing section 4004 deletes the merchandise information related to the cancellation completion notification from the transaction information section 413.

The information processing section 4005 executes various information processing. For example, when the transmitting and receiving section 4001 receives the accounting screen display instruction from the server device 2, the information processing section 4005 generates an accounting barcode to be displayed on the display unit 42. The accounting barcode includes a terminal code encoded therein or the like.

The display control section 4006 is an example of a first display means and a second display means. The display control section 4006 causes the display unit 42 to display various types of information. For example, the display control section 4006 causes the display unit 42 to display the merchandise information and transaction amount stored in the transaction information section 413. The transaction amount may be acquired from the server device 2 or may be calculated by the information processing section 4005 based on transaction information stored in the transaction information section 413. When the transmitting and receiving section 4001 receives the confirmation screen display instruction, the display control section 4006 causes the display unit 42 to display a confirmation screen for confirming whether to execute the cancellation. When retention information is transmitted together with the confirmation screen display instruction, the display control section 4006 displays the contents of the retention information in the confirmation screen. When the transmitting and receiving section 4001 receives the accounting screen display instruction from the server device 2, the display control section 4006 causes the display unit 42 to display the accounting barcode generated by the information processing section 4005.

The accounting machine 5 can be generally similar in basic configuration to the server device 2 and/or the customer terminal 4 described above. The accounting machine 5 can include a software-configured control unit comprising a CPU, a ROM, a RAM, and the like for executing software or the like. The accounting machine 5 includes a storage unit such as an HDD and a flash memory that store various programs, a display device such as a liquid crystal panel, an operation unit (user input unit) configured of input devices such as a keyboard and a touch panel, a scanner unit that can read a code symbol (e.g., an accounting barcode), a communication unit (interface) for communicating with external devices, and the like. The control unit of the accounting machine 5 executes various processes such as the accounting process by executing programs stored in the storage unit.

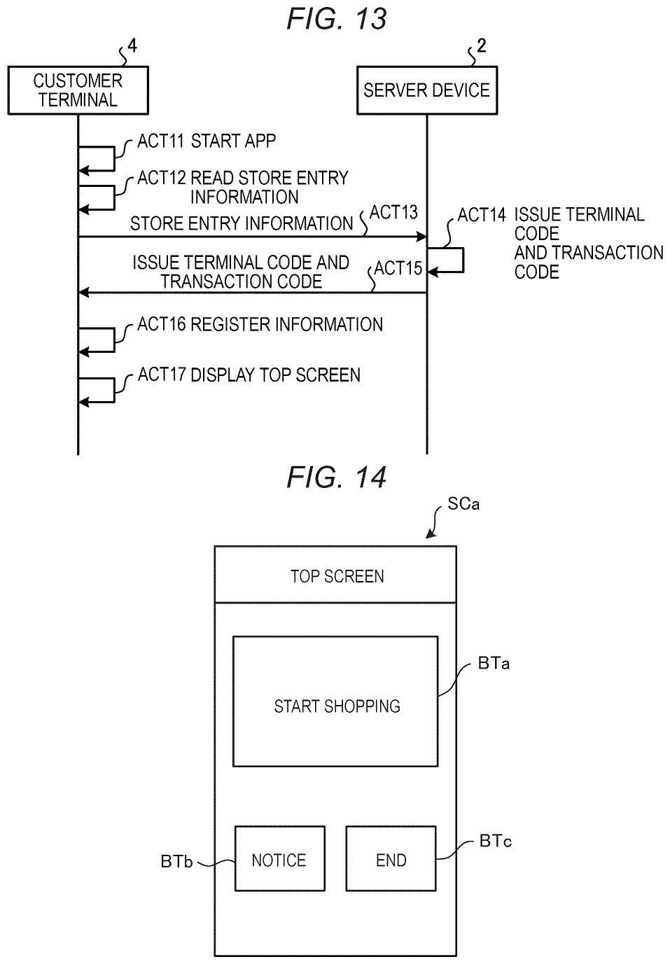

Next, an outline of an operation of the store support system 1 will be described. FIG. 13 is a sequence chart illustrating an example of operations of the store support system 1.

First, a customer starts an application program for a mobile self-checkout system (ACT 11). Next, the customer inputs a transaction start by reading a code symbol for entering the store (such code symbol is typically located at the store entrance) or the like using the customer terminal 4 (ACT 12). The code symbol for entering the store includes encoded therein, or associated therewith, a company code, a store code, and the like.

The transmitting and receiving section 4001 transmits store entry information (including the company code and the store code) read from the store entry code symbol and the check-in time (indicating the current date and time) to the server device 2 (ACT 13).

When the transmitting and receiving section 2001 receives the store entry information, the information managing section 2002 of the server device 2 issues a terminal code and a transaction code (ACT 14). Here, the information managing section 2002 registers necessary information in the terminal management table 213 and the transaction information management table 214 based on the received store entry information. The transmitting and receiving section 2001 transmits the terminal code and the transaction code to the customer terminal 4 (ACT 15).

The information managing section 4004 of the customer terminal 4 registers the information received by the transmitting and receiving section 4001 (ACT 16). Specifically, the information managing section 4004 registers the terminal code in the terminal code section 412 and the transaction code in the transaction information section 413, respectively. Next, the display control section 4006 causes the display unit 42 to display a “top screen” from which instructions can be given to start shopping or transmit an information request (ACT 17).

FIG. 14 is a diagram illustrating an example of a top screen displayed by the customer terminal 4. As illustrated in FIG. 14, a top screen SCa includes a first button BTa, a second button BTb, and a third button BTC.

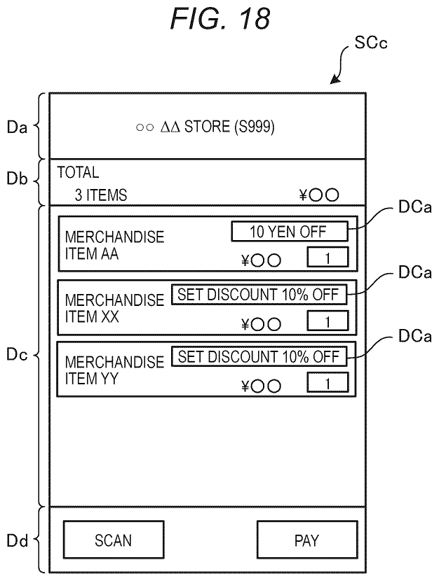

The first button BTa is for instructing to start shopping. When the first button BTa is pressed, the reading section 4003 cooperates with the input section 4002 and the imaging unit 44 to permit a merchandise barcode to be read with the customer terminal 4. The display control section 4006 causes the display unit 42 to display a transaction information screen (see FIG. 18) for displaying the merchandise information and transaction amount of the read merchandise item.

The second button BTb is for instructing transmission of an information request. When the second button BTb is pressed, the transmitting and receiving 4001 section transmits an information request to the server device 2 and, in turn, receives sales promotion information transmitted from the server device 2. The display control section 4006 causes the display unit 42 to display a sales promotion screen (see FIG. 16) for displaying the sales promotion information.

The third button BTc is for instructing termination of the application program. When the third button BTc is pressed, the transmitting and receiving transmits section 4001 a termination request (including terminal code) to the server device 2. The display control section 4006 ends the display of the top screen when the application program is terminated. When the transmitting and receiving section 2001 receives the termination request, the information managing section 2002 may delete data related to the termination request from the terminal management table 213 and the transaction information management table 214.

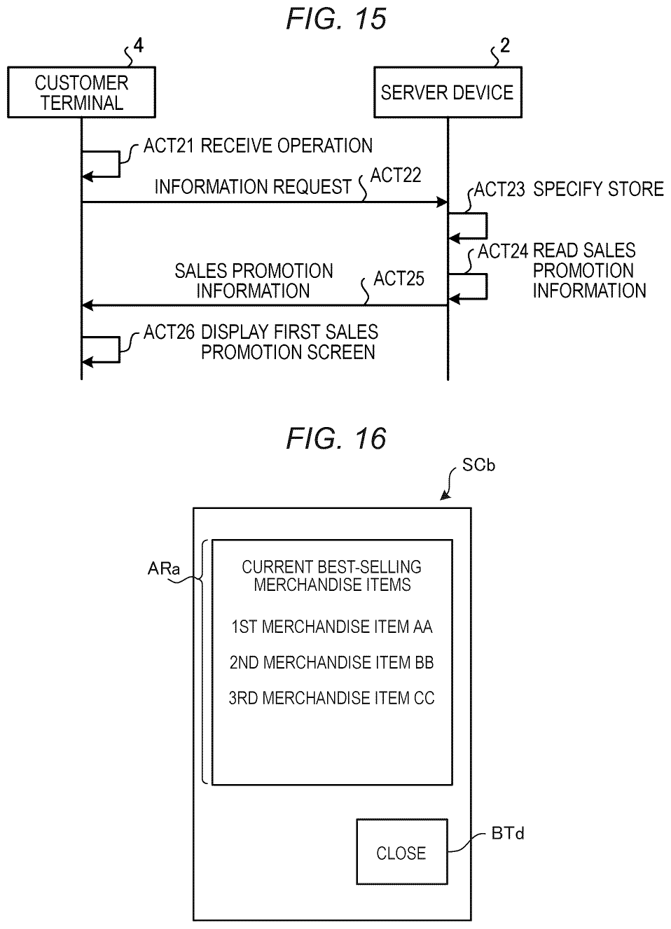

Next, with reference to FIG. 15, the operation of the store support system 1 when the second button BTb is pressed will be described. FIG. 15 is a sequence chart illustrating an example of operations of the store support system 1.

When the second button BTb is pressed (ACT 21), the transmitting and receiving section 4001 transmits an information request to the server device 2 (ACT 22).

When the transmitting and receiving section 2001 receives the information request, the information providing section 2004 identifies the store where the customer is located by referring to the terminal management table 213 and identifying the store code that corresponds to the terminal code in the information request (ACT 23). Next, the information providing section 2004 reads sales promotion information about the best-selling merchandise items and the recommended merchandise items for the store (identified in ACT 22) from the merchandise master 212, the best-selling merchandise table 217, and the recommended merchandise table 218 (ACT 24). Then, the information providing section 2004 transmits the sales promotion information to the customer terminal 4 (ACT 25).

When the transmitting and receiving section 4001 receives the sales promotion information, the display control section 4006 causes the display unit 42 of the customer terminal 4 to display a sales promotion screen (referred to as a first sales promotion screen) based on the received sales promotion information (ACT 26).

FIG. 16 is a diagram illustrating an example of a first sales promotion screen displayed by a customer terminal 4. As illustrated in FIG. 16, a first sales promotion screen SCb includes an area ARa for displaying sales promotion information. Content based on the received sales promotion information is displayed in the area ARa. For example, in the area ARa, information regarding the current best-selling merchandise items and recommended merchandise items is displayed. FIG. 16 illustrates an example in which a ranking of best-selling merchandise items is displayed.

By viewing the first sales promotion screen SCb, the customer operating the customer terminal 4 can easily see which merchandise items are the best sellers and and/or price discounted merchandise items at the store. Therefore, the store support system 1 can provide sales support and purchase support for the merchandise items sold at the store.

The first sales promotion screen SCb is provided with a close button BTd for instructing to close the first sales promotion screen SCb. When the close button BTd is pressed, the display control section 4006 closes the first sales promotion screen SCb and displays the top screen SCa again.

The first sales promotion screen SCb may be displayed as a pop-up over the top screen SCa in some examples. In such a case, when the close button BTd is pressed, the display control section 4006 ends the pop-up display of the first sales promotion screen SCb.

In the present embodiment, the sales promotion information is transmitted from the server device 2 upon explicit request by the customer, that is, through the pressing of the second button BTb. However, the present disclosure is not limited thereto, and sales promotion information may be transmitted from the server device 2 as a push notification.

For example, the information providing section 2004 may provide sales promotion information to the customer terminal 4 upon the transmitting and receiving section 2001 receiving the store entry information. For example, the information providing section 2004 may provide sales promotion information to the customer terminal 4 when the ranking of best-selling merchandise items is updated or at any other timing.

In such cases, the information managing section 4004 may hold (store) the sales promotion information transmitted from the server device 2 in the RAM 203 or the like, and the display control section 4006 may then subsequently display the first sales promotion screen SCb based on the already stored sales promotion information. The display control section 4006 may display the first sales promotion screen SCb when the second button BTb is pressed or whenever the sales promotion information is transmitted from the server device 2.

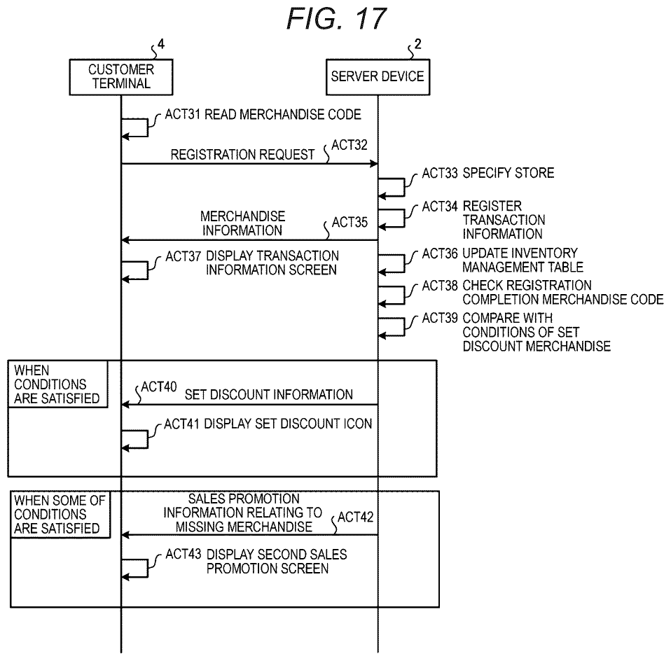

Next, with reference to FIG. 17, the operation of the store support system 1 related to merchandise registration will be described. FIG. 17 is a sequence chart illustrating an example of operations of the store support system 1.

After pressing of the first button BTa, the reading section 4003 reads a merchandise code that specifies the merchandise item from the merchandise barcode in an image provided by the customer imaging the merchandise barcode with the imaging unit 44 (ACT 31). The merchandise code of a merchandise item without a barcode can be input from the operation unit 43.

Next, the transmitting and receiving section 4001 transmits a registration request (including the terminal code and a merchandise code) to the server device 2 (ACT 32). The transmitting and receiving section 4001 may transmit a registration request that includes a transaction code instead of the terminal code to the server device 2 or the transaction code and terminal code may both be sent together. In the following description of examples, it is assumed that whenever the customer terminal 4 transmits information to the server device 2, a terminal code is also transmitted therewith.

When the transmitting and receiving section 2001 receives a registration request, the information managing section 2002 refers to the terminal management table 213 and identifies the store code corresponding to the terminal code in the registration request (ACT 33).

Next, the information managing section 2002 executes merchandise registration in response to the registration request based on the specified store code, the terminal code, and the merchandise code. Specifically, the information managing section 2002 reads out merchandise information corresponding to the specified store code and merchandise code from the merchandise master 212. The information managing section 2002 associates the read merchandise information and information indicating the current date and time (registration time) with the terminal code and registers the associated information in the transaction information management table 214 (ACT 34). Next, the information managing section 2002 transmits the read merchandise information to the customer terminal 4 (ACT 35).

The information managing section 2002 updates the inventory management table 215 by adding to the number of registered items of the merchandise item (ACT 36). The information managing section 2002 may also update the best-selling merchandise table 217 in ACT 36 as necessary.

After the received merchandise information is stored in the transaction information section 413 by the information managing section 4004, the display control section 4006 displays a transaction information screen on the display unit 42 based on the merchandise information that was stored in the transaction information section 413 (ACT 37). Each time the customer terminal 4 reads a merchandise code, the customer terminal 4 may acquire transaction information including all the pieces of merchandise information related to the current transaction registered in the transaction information management table 214.

FIG. 18 is a diagram illustrating an example of a transaction information screen displayed by the customer terminal 4. The transaction information screen is an example of a first screen. As illustrated in FIG. 18, a transaction information screen SCc includes a header section Da, a total information section Db, a merchandise information section Dc, and a footer section Dd.

In the header section Da, a company name “oo”, a store name “ΔΔ store”, and the like are displayed. The terminal code (“S999”) stored in the terminal code section 412 is displayed in the header section Da.

The total number and total price of registered merchandise items are displayed in the total information section Db. For merchandise items eligible for price discounts, the total price may be calculated based on the discounted price. Merchandise items cancelled after being registered are not included in the total number and total price.

The merchandise information section Dc displays information about registered merchandise items. The displayed merchandise information includes the merchandise name, price, tax rate, number of items, and additional information. For example, when the additional information includes information indicating that the merchandise item is eligible for price reduction or discount, an icon Dca is displayed to indicate this eligibility.

In the merchandise information section Dc, it is possible to instruct cancellation of merchandise registration by a predetermined operation or the like. For cancelled merchandise items, the merchandise name, price, and number of items will be displayed crossed out (strikethrough).

Various buttons or icons are displayed in the footer section Dd. Specifically, a “scan” button, a “pay” button, and the like are displayed in the footer section Dd. The “scan” button is pressed for capturing an image of a merchandise barcode. The “pay” icon is pressed for sending accounting instructions.

The buttons or icons displayed in the footer section Dd are not limited to the example illustrated in FIG. 18. For example, a button similar to the second button BTb may be displayed in the footer section Dd. With such a configuration, it is possible to instruct the display of sales promotion information from the transaction information screen SCc as well.

Returning to FIG. 17, an operation of the store support system 1 will be described. By referring to the merchandise information registered in the transaction information management table 214 and other pieces of merchandise information registered for the same terminal code, the information providing section 2004 checks the merchandise code(s) registered by the customer (ACT 38). Next, the information providing section 2004 compares a merchandise code registered in the transaction information management table 214 to the merchandise codes corresponding to the set discount merchandise items registered in the recommended merchandise table 218 (ACT 39).

Here, when a merchandise code registered in the transaction information management table 214 is one the items in a group (set) discount grouping (set), the information providing section 2004 transmits group discount information including the set of other merchandise codes that satisfy the group discount conditions along with recommendation information to the customer terminal 4 (ACT 40).

After the received group discount information is stored in the transaction information section 413 by the information managing section 4004, the display control section 4006 can display an icon Dca indicating that the group (set) discount has been established (ACT 41).

When the merchandise code(s) registered in the transaction information management table 214 satisfies only part of the conditions for a group (set) discount, the information providing section 2004 transmits sales promotion information including the missing merchandise codes for group (set) discount eligibility and the recommendation information for the other (missing) merchandise item(s) to the customer terminal 4 (ACT 42).

When the transmitting and receiving section 4001 receives sales promotion information, the display control section 4006 causes the display unit 42 to display a sales promotion screen (referred to as a second sales promotion screen) related to the missing merchandise items (ACT 43).

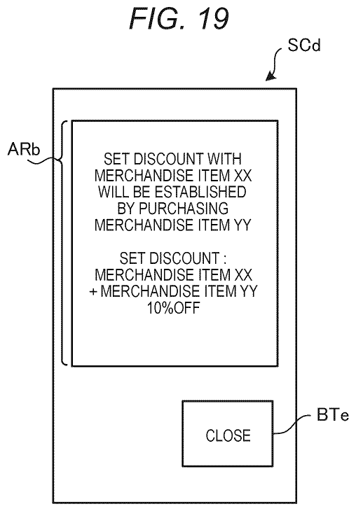

FIG. 19 is a diagram illustrating an example of the second sales promotion screen displayed by the customer terminal 4. As illustrated in FIG. 19, a second sales promotion screen SCd, like the first sales promotion screen SCb, includes an area Arb for displaying sales promotion information. Content based on sales promotion information is displayed in the area Arb. For example, in the area Arb, the merchandise name or other information of the missing merchandise items that are necessary for satisfying the conditions of the group (set) discount are displayed. FIG. 19 illustrates an example where it is displayed that by purchasing a merchandise item YY, a group (set) discount in conjunction with a merchandise item XX will be established, and that the discount will be a 10% discount.

Therefore, by viewing the second sales promotion screen SCd, the customer operating the customer terminal 4 can easily check which additional merchandise item(s) to purchase to meet a group (set) discount offer. Therefore, the store support system 1 can provide sales support and purchase support for merchandise items sold at the store.

The second sales promotion screen SCd is provided with a close button BTe for instructing to close the second sales promotion screen SCd. When the close button BTe is pressed, the display control section 4006 closes the second sales promotion screen SCd and displays the transaction information screen SCc again.

The second sales promotion screen SCd may be displayed as a pop-up over the transaction information screen SCc, for example. In such cases, the display control section 4006 ends the pop-up display of the second sales promotion screen SCd when the close button BTe is pressed.

In the present embodiment, sales promotion information is displayed for a set (group) discount merchandise item, but the present disclosure is not limited thereto, and sales promotion information may also or instead be displayed for a recipe merchandise item. In such a case, when a merchandise code registered in the transaction information management table 214 satisfies part of the recipe merchandise items of a particular recipe or the like, the information providing section 2004 transmits sales promotion information including the still missing merchandise code(s) and recommendation information for these recipe merchandise items to the customer terminal 4.

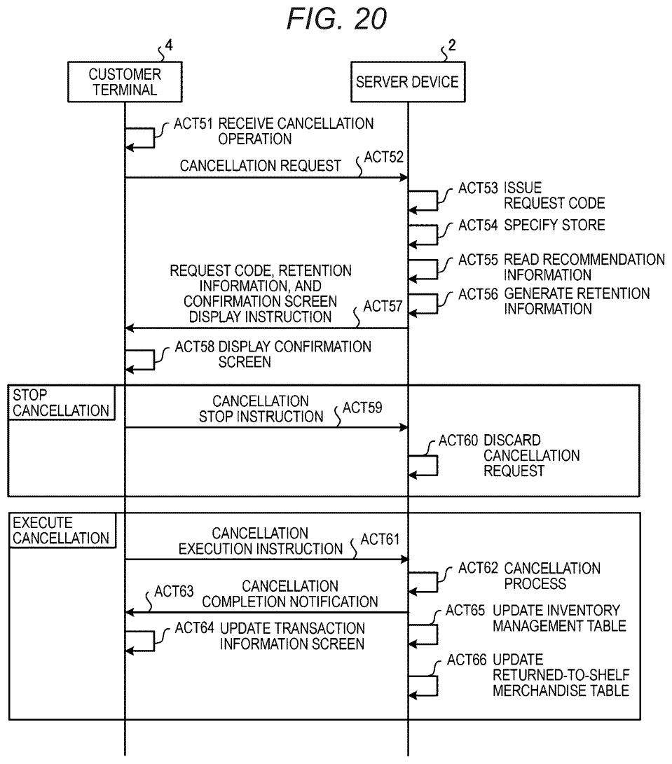

Next, with reference to FIG. 20, an operation of the store support system 1 related to cancellation of a merchandise registration will be described. FIG. 20 is a sequence chart illustrating an example of operations of the store support system 1. It is assumed that the transaction information screen is initially displayed on the customer terminal 4.

When the transmitting and receiving section 4001 of the customer terminal 4 receives a cancellation operation (ACT 51), the transmitting and receiving section 4001 transmits a cancellation request (including the terminal code and the merchandise code of the merchandise item to be cancelled) to the server device 2 (ACT 52).

When the transmitting and receiving section 2001 of the server device 2 receives the cancellation request from the customer terminal 4, the transmitting and receiving section 2001 issues a request code corresponding to the cancellation request (ACT 53). The information providing section 2004 refers to the terminal management table 213 and specifies the store code corresponding to the terminal code in the cancellation request (ACT 54).

Next, the information providing section 2004 refers to the recommended merchandise table 218 and reads any recommendation information corresponding to conditions such as the specified store code and the merchandise code in the cancellation request (ACT 55). For example, when the merchandise code in the cancellation request corresponds to a price discounted merchandise item, the information providing section 2004 reads recommendation information for the price discounted merchandise item. When the merchandise code in the cancellation request is for a set discount merchandise item or recipe merchandise item, the information providing section 2004 reads recommendation information for the set discount merchandise item or recipe merchandise item.

Subsequently, the information providing section 2004 generates retention information including a message suggesting stopping of the cancellation based on the recommendation information read in ACT 55 (ACT 56). Next, the information providing section 2004 cooperates with the transmitting and receiving section 2001 to transmit the request code and retention information to the customer terminal 4 along with a confirmation screen display instruction (ACT 57).

When the transmitting and receiving section 4001 receives the request code, the retention information, and the confirmation screen display instruction, the display control section 4006 of the customer terminal 4 causes the display unit 42 to display a confirmation screen for confirming whether to cancel the merchandise item based on the retention information (ACT 58). That is, the confirmation screen includes aspects related to the provided retention information.

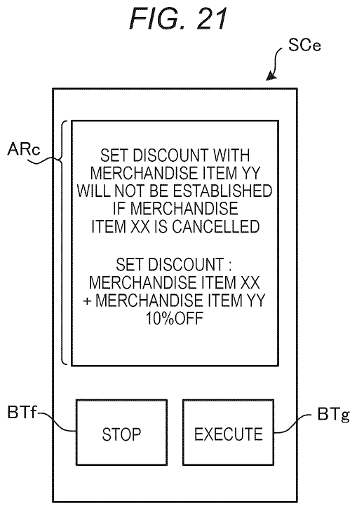

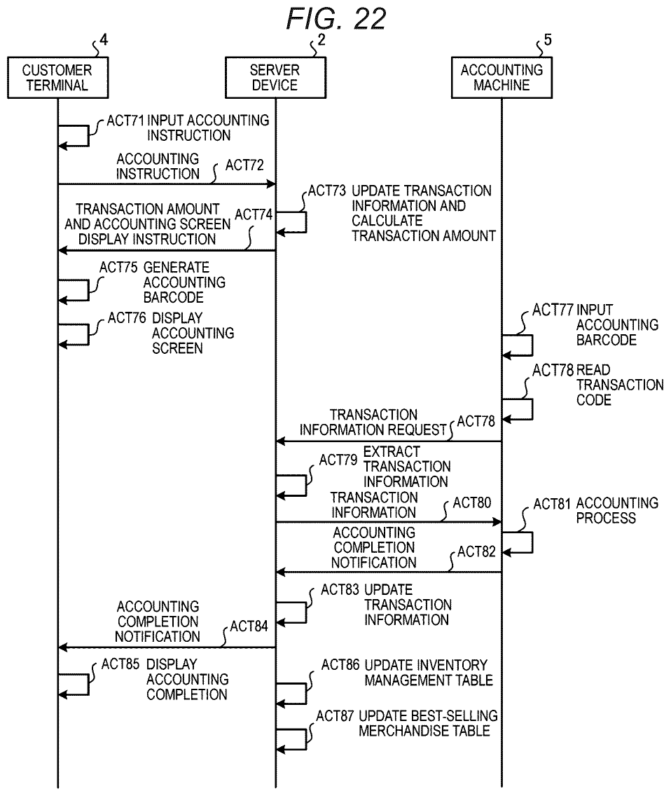

FIG. 21 is a diagram illustrating an example of a confirmation screen displayed by the customer terminal 4. The confirmation is an example of a second screen. As illustrated in FIG. 21, a confirmation screen SCe includes an area ARc for displaying retention information. In the area ARC, content based on the retention information are displayed. For example, in the area ARc, information indicating that the merchandise item is a part of a group of items for which a group (set) discount may be provided if purchased together may be displayed. For example, if cancellation of a set discount merchandise item is about to be made, information indicating that a previously applied discount will not be applied if the merchandise item is cancelled may be displayed. FIG. 21 illustrates an example where it is displayed that a 10% discount will not be established due to the cancellation of the merchandise item XX, which is a part of set discount merchandise items.

The confirmation screen SCe is provided with a stop button BTf and an execution button BTg. The stop button BTf is an for instructing stop of a cancellation. The execution button BTg is for instructing execution of a cancellation. When the stop button BTf is pressed, the transmitting and receiving section 4001 transmits a cancellation stop instruction including a request code to the server device 2. When the execution button BTg is pressed, the transmitting and receiving section 4001 transmits a cancellation execution instruction including a request code to the server device 2.

As such, in the customer terminal 4, when an operation for cancelling a merchandise item is performed, retention information indicating a reason for holding back (stopping) the cancellation of the merchandise item is displayed on the confirmation screen SCe. Therefore, a customer operating the customer terminal 4 can consider whether to cancel the merchandise item in view of the supplied retention information displayed on the confirmation screen SCe. The customer can then decide to stop or execute the cancellation.

In the store support system 1, when a cancellation is requested for a merchandise item that has been already registered, an opportunity to review the cancellation can be provided, thereby reducing the possibility of an inadvertent or unconsidered cancellation. Therefore, the store support system 1 can support customers in purchasing merchandise items. The store support system 1 can also reduce the occurrence of returns to shelf and therefore can provide support for merchandise sales at stores.

Returning to FIG. 20, when an operation to stop (abandon) the cancellation is performed on the confirmation screen, the transmitting and receiving section 4001 transmits a cancellation stop instruction including a request code to the server device 2 (ACT 59). The display control section 4006 of the customer terminal 4 then erases the confirmation screen.

When the transmitting and receiving section 2001 of the server device 2 receives the cancellation stop instruction from the customer terminal 4, the transmitting and receiving section 2001 discards the corresponding cancellation request (ACT 60).

When an operation to execute cancellation is performed on the confirmation screen, the transmitting and receiving section 4001 of the customer terminal 4 transmits a cancellation execution instruction including a request code to the server device 2 (ACT 61). The display control section 4006 then erases the confirmation screen.

When the transmitting and receiving section 2001 receives a cancellation execution instruction from the customer terminal 4, the information managing section 2002 of the server device 2 performs a process to cancel (e.g., delete or flag) merchandise information in the transaction information management table 214 based on the cancellation request (ACT 62). Specifically, the information managing section 2002 searches the transaction information management table 214 for the merchandise information entry corresponding to the terminal code and the merchandise code in the cancellation request, and rewrites the cancellation flag to “1”.

Next, the information managing section 2002 cooperates with the transmitting and receiving section 2001 to transmit a cancellation completion notification (including the merchandise code of the cancelled merchandise item) to the customer terminal 4 (ACT 63).

When the transmitting and receiving section 4001 receives the cancellation completion notification, the display control section 4006 of the customer terminal 4 updates the transaction information screen by adding a strikethrough line over the merchandise item corresponding to the merchandise code in the cancellation completion notification on the transaction information screen (ACT 64).

The information managing section 2002 of the server device 2 executes the following processing upon cancellation of merchandise information. The information managing section 2002 updates the inventory management table 215 by subtracting 1 from the number of registered items (ACT 65). The information managing section 2002 also updates the returned-to-shelf merchandise table 216 by adding 1 to the number of returns to shelf (ACT 66). Next, with reference to FIG. 22, an operation of the store support system 1 related to merchandise accounting will be described. FIG. 22 is a sequence chart illustrating an example of operations of the store support system 1. It is assumed that the transaction information screen is initially displayed on the customer terminal 4.

When the customer finishes registering the merchandise items and presses the “pay” button on the transaction information screen and the accounting instruction is input to the customer terminal 4 (ACT 71). The transmitting and receiving section 4001 of the customer terminal 4 then transmits the accounting instruction to the server device 2 (ACT 72).

When the transmitting and receiving section 2001 receives the accounting instruction, the information managing section 2002 updates transaction information and calculates the transaction amount (ACT 73). Specifically, the information managing section 2002 registers the accounting instruction time in the accounting instruction in the transaction information management table 214. The information managing section 2002 calculates the transaction amount based on the merchandise information corresponding to the transaction code. The transmitting and receiving section 2001 transmits the transaction amount (as calculated by the information managing section 2002) and the accounting screen display instruction to the customer terminal 4 (ACT 74).

When the transmitting and receiving section 4001 receives the transaction amount and the accounting screen display instruction, the display control section 4006 of the customer terminal 4 generates an accounting barcode encoding or otherwise indicating the transaction code (ACT 75). Next, the display control section 4006 displays an accounting screen including the accounting barcode thereon along with the transaction amount (ACT 76).

Subsequently, at the accounting machine 5, the accounting barcode displayed on the accounting screen of the customer terminal 4 is scanned by the scanner unit and input to the accounting machine 5 (ACT 77). The accounting machine 5 reads the transaction code from the accounting barcode and transmits a transaction information request (including the transaction code) to the server device 2 (ACT 78).

When the transmitting and receiving section 2001 receives the transaction information request, the information managing section 2002 extracts transaction information corresponding transaction code from the transaction information management table 214 (ACT 79). Next, the transmitting and receiving section 2001 transmits the transaction information extracted by the information managing section 2002 to the accounting machine 5 (ACT 80).

When a transaction information request including a terminal code is received from the accounting machine 5, the information managing section 2002 of the server device 2 extracts transaction information corresponding to the terminal code from the transaction information management table 214 in ACT 78.

After the accounting machine 5 acquires the transaction information from the server device 2, the accounting machine 5 executes an accounting process based on the transaction information (ACT 81). For example, the accounting machine 5 executes a cash payment or cashless payment based on the customer's selections or preferences. When the accounting process is completed, the accounting machine 5 transmits an accounting completion notification to the server device 2 (ACT 82).

The information managing section 2002 of the server device 2 updates transaction information based on the accounting completion notification (ACT 83). Specifically, the information managing section 2002 rewrites the accounting completion flag to “1” in the transaction information management table 214 for the transaction code.

Subsequently, the transmitting and receiving section 2001 transmits the accounting completion notification to the customer terminal 4 (ACT 84). Specifically, the transmitting and receiving section 2001 transmits the accounting completion notification to the customer terminal 4 specified by the terminal code corresponding to the transaction code in the accounting completion notification received from the accounting machine 5.

When the transmitting and receiving section 4001 receives the accounting completion notification, the display control section 4006 of the customer terminal 4 displays information indicating that the accounting has been completed on the display unit 42 (ACT 85).

The information managing section 2002 of the server device 2 executes the following processing in conjunction with an update of transaction information. The information managing section 2002 updates the inventory management table 215 based on the merchandise code of which the cancellation flag is “0” in the updated transaction information (ACT 86). Specifically, the information managing section 2002 counts the number of items for each type of merchandise code in the transaction information, subtracts the number from the corresponding number of registered items, and adds the number to the number of sold items. The information managing section 2002 also updates the best-selling merchandise table 217 based on the updated transaction information and the updated inventory management table 215 (ACT 87).

As described above, the customer terminal 4 displays a transaction information screen representing or listing each registered merchandise item in the transaction and receives a registration cancellation operation on the transaction information screen as necessary. The customer terminal 4 then displays the retention information related to merchandise item that is the target of the cancellation operation on a cancellation confirmation screen. The cancellation confirmation screen permits the user (customer) to select whether to execute (continue) or stop (abandon) the instructed cancellation. When the execution of the cancellation is selected, the customer terminal 4 performs the processing to cancel the registration of the target merchandise item.

As a result, the customer terminal 4 can present a confirmation screen showing retention information regarding the target merchandise item to the customer and this may prompt the customer to abandon the cancellation. Therefore, the customer terminal 4, in conjunction with the store support system 1, can reduce cancellations of registered purchase targets.

In particular, customer terminal 4 may display, on the cancellation confirmation screen, information representing benefits that would result from purchasing the merchandise item targeted for cancellation and/or information representing the disadvantages that would result from not purchasing (cancelling) the target merchandise item. Such benefits, advantages, and disadvantages can be referred to as retention information when shown on the confirmation screen. Thereby, the customer terminal 4 can present a reason to the customer for abandoning the cancelling of the purchase of the targeted merchandise item. Such presentation may prompt the customer to stop the cancellation. Therefore, the customer terminal 4 and the store support system 1 can reduce cancellations.

The server device 2 manages transactions performed on the customer terminal 4 by associating transaction specifying information with the merchandise items registered in the transaction. In response to a registration request transmitted from the customer terminal 4, the server device 2 registers the merchandise item instructed to be registered by the registration request in association with the transaction specifying information of the customer terminal 4. When the server device 2 receives a cancellation request instructing the cancellation of a previously registered merchandise item from the customer terminal 4, the server device 2 provides specifically targeted retention information to the customer terminal 4 and causes the retention information to be displayed.

Therefore, since the server device 2 can present a screen displaying retention information to the customer operating the customer terminal 4, it is possible to prompt the customer to stop a cancellation. Therefore, the server device 2 and the store support system 1 can reduce cancellations.

The device 2 server generates information representing benefits resulting from purchasing the cancellation target and information representing disadvantages resulting from cancelling as retention information, and provides the information to the customer terminal 4 for display. Thereby, the server device 2 can present a reason for abandoning the cancellation to the customer operating the customer terminal 4, thereby possibly prompting the customer to cancel the cancellation and continue with the purchase of the merchandise item. Therefore, the customer terminal 4 and the store support system 1 can reduce cancellations.

In an embodiment, the control programs executed by each of the server device 2, the customer terminal 4, and the accounting machine 5 may be recorded and/or provided on a non-transitory, computer-readable recording medium such as a CD-ROM. In other examples, the control programs to be executed by each device may be stored on a computer connected to a network such as the Internet, and provided by being downloaded or otherwise accessed via the network. The control program may be configured to be provided via a network such as the Internet.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A mobile merchandise registration device, comprising:
a display to display information to a user while shopping in a store;
an input unit for receiving user inputs from the user;
a communication interface to connect to a server device tracking a sales transaction of the user at the store; and
a control unit configured to:
display a first screen on the display, the first screen for listing each merchandise item registered as purchase targets in the sales transaction;
receive a cancellation operation, via the input unit, for cancelling the registration of a merchandise item as a purchase target listed on the first screen;
after receiving the cancellation operation, display a second screen on the display, the second screen being a cancellation operation confirmation screen and including sales retention information regarding the merchandise item that is a subject of the cancellation operation; and
cause the registration of the merchandise item that is the subject of the cancellation operation to be cancelled if the user confirms the cancellation operation via the second screen.

2. The mobile merchandise registration device according to claim 1, wherein the sales retention information describes a price discount associated with purchase of the merchandise item.

3. The mobile merchandise registration device according to claim 1, wherein the sales retention information describes a price discount that will be lost when registration of the merchandise item is cancelled.

4. The mobile merchandise registration device according to claim 1, wherein the sales retention information is received via the communication interface from the server device in response to a cancellation request associated with the cancellation operation.

5. A cart-based point-of-sale apparatus, comprising:
a shopping cart;
a mobile merchandise registration device according to claim 4, wherein
the mobile merchandise registration device is mounted to the shopping cart.

6. A cart-based point-of-sale apparatus, comprising:
a shopping cart;
a mobile merchandise registration device according to claim 1, wherein
the mobile merchandise registration device is mounted to the shopping cart.

7. The mobile merchandise registration device according to claim 1, further comprising:
a camera to acquire images of merchandise items for registering the merchandise items as purchase targets in the sales transaction.

8. A store sales support system, comprising:
a server device configured to track a sales transaction of a customer at a store; and
a mobile merchandise registration device including:
a display to display information to customer while shopping in the store;
an input unit for receiving user inputs from the customer;
a communication interface connected to the server device; and
a control unit configured to:
display a first screen on the display, the first screen for listing each merchandise item registered as purchase targets in the sales transaction;
receive a cancellation operation, via the input unit, for cancelling the registration of a merchandise item as a purchase target listed on the first screen;
after receiving the cancellation operation, display a second screen on the display, the second screen being a cancellation operation confirmation screen and including sales retention information regarding the merchandise item that is a subject of the cancellation operation; and
cause the registration of the merchandise item that is the subject of the cancellation operation to be cancelled if the user confirms the cancellation operation via the second screen.

9. The store sales support system according to claim 8, wherein the sales retention information describes a price discount associated with purchase of the merchandise item.

10. The store sales support system according to claim 8, wherein the sales retention information describes a price discount that will be lost when registration of the merchandise item is cancelled.

11. The store sales support system according to claim 8, wherein the sales retention information is received via the communication interface from the server device in response to a cancellation request associated with the cancellation operation.

12. The store sales support system according to claim 11, wherein the mobile merchandise registration device is mounted to a shopping cart.

13. The store sales support system according to claim 8, wherein the mobile merchandise registration device is mounted to a shopping cart.

14. The store sales support system according to claim 8, wherein the mobile merchandise registration device further includes a camera to acquire images of merchandise items for registering the merchandise items as purchase targets in the sales transaction.

15. A method for a mobile merchandise registration device, the method comprising:
displaying information on a display of a mobile merchandise registration device to a user while the user is shopping in a store;
receiving user inputs from the user via an input unit of the mobile merchandise registration device;
connecting, via a communication interface of the mobile merchandise registration device to a server device tracking a sales transaction of the user at the store; and
displaying a first screen on the display, the first screen for listing each merchandise item registered as purchase targets in the sales transaction;
receiving a cancellation operation, via the input unit, for cancelling the registration of a merchandise item as a purchase target listed on the first screen;
after receiving the cancellation operation, displaying a second screen on the display, the second screen being a cancellation operation confirmation screen and including sales retention information regarding the merchandise item that is a subject of the cancellation operation; and
causing the registration of the merchandise item that is the subject of the cancellation operation to be cancelled if the user confirms the cancellation operation via the second screen.

16. The method according to claim 15, wherein the sales retention information describes a price discount associated with purchase of the merchandise item.

17. The method according to claim 15, wherein the sales retention information describes a price discount that will be lost when registration of the merchandise item is cancelled.

18. The method according to claim 15, wherein the sales retention information is received via the communication interface from the server device in response to a cancellation request associated with the cancellation operation.

19. The method according to claim 15, wherein the mobile merchandise registration device is mounted to a shopping cart.

20. The method according to claim 15, further comprising:
acquiring images of merchandise items with a camera of the mobile merchandise registration device for registering the merchandise items as purchase targets in the sales transaction.
